(19) United States
(12) Patent Application Publication
(10) Pub. No.: US 2004/0148590 A1
(43) Pub. Date: Jul. 29, 2004

(54) Hierarchical test suite

(75) Inventors: Viktor V. Lapitski, Palo Alto, CA (US); Alexandre S. Iline, Mountain View, CA (US); Anatoli Fomenko, San Jose, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/352,555

(22) Filed: Jan. 27, 2003

(51) Int. Cl. G06F 9/44

(52) U.S. Cl. 717/124

(57) ABSTRACT

A hierarchical multi-level logical architecture for a test suite may be provided along with a harness that supports such architecture. At each level in the hierarchy, instructions at the level may be run. A subset of test cases corresponding to the test case currently being examined may then be obtained (which may have been passed by a parent). Then a loop may be entered wherein for each test case in the list of test cases, the test case is executed and the result put into a special data structure, which may then be labeled and returned to the parent. This iterative process allows for multi-level test cases without suffering the drawbacks of the prior art.

### FIELD OF THE INVENTION

The present invention relates to the field of software testing. More particularly, the present invention relates to a test suite that provides functionality for hierarchical testing of software.

### BACKGROUND OF THE INVENTION

When software is developed, typically it must be extensively tested before it is deemed ready for use or sale. FIG. 1 is a diagram illustrating a typical test suite. A test harness 100 executes a portion of the software using one or more testcases 102a, 102b, 102c. Each testcase 102a, 102b, 102c contains instructions as to how to perform a test, and the result from the hardness is a pass or fail (or error) for each of the test cases 102a, 102b, 102c. Thus, the harness is started for test case 102a, run on test case 102a, then produces a result for test case 102a, then the harness is started for test case 102b, run on test case 102b, and produces a result for test case 102b, and so on. Thus, the result of a test suite executed is generally some form of a list of test case name/status association pairs.

However, in practice, there are various types of dependencies caused by optimizing or eliminating repetitive steps among the test cases. For example, suppose a set of testcases has subsets (T₁₁, . . . , T₁N₁, . . . , T₂₁, . . . , T₂N₂, . . . , Tₖ₁, . . . , TₖNₖ) such that:

(1) for each test Tᵢⱼ, an environment created by common step Sᵢ is required.

(2) the step Sᵢ is very expensive in terms of execution

(3) it is permissible for testcases Tᵢₗ-TᵢNᵢ to be executed sequentially in the same environment once the Sᵢ is performed (i.e., execution of sequence Sᵢ, Tᵢ, . . . , TᵢNᵢ in the same environment instance is acceptable).

Typically, this example could be handled in one of three ways. First, for each test Tᵢⱼ, the harness could execute each Sᵢ, Tᵢⱼ pair in a new environment instance. The disadvantage here, however, is that the execution will be very expensive in terms of processor time. The second way this could be handled would be for each set Sᵢ, (Tᵢₗ, . . . ,TᵢNᵢ) to be organized as a single test case. The disadvantage here, however is that there is a loss of granularity. Only one execution status will be reported for the whole subset of test cases, thus not reporting the real execution picture. Individual Tᵢⱼ results could be reported by internal infrastructure of a combined testcase in some separate way (like log files), but that would require additionally developed processing later, which is not provided by the harness. Additionally, a harness usually provides some relatively convenient ways to add or exclude test cases from the execution set, but these can only be applied here for the whole combined test case. The third way this could be handled is that for each set Sᵢ, (Tᵢₗ, . . . , TᵢNi) a separate execution of the harness could be run. However, this way also shares the disadvantages of the prior two.

Another example of a type of dependency having repetitive steps among the test cases is where the set of test cases contains the following subsets:

([T₁₁],[T₁₁,T₁₂], . . . , [T₁₁, . . . ,T₁N₁], . . . ,[TK₁], . . . , [TK₁, . . . ,TKNK], . . . ). In other words, there are subsets comprising test cases such as:

[T₁₁]—perform action “A₁”, check assertion “C₁”

[T₁₁,T₁₂]—perform action “A₁”, perform action “A₂”, check assertion “C₂”

It may be assumed that actions Aᵢ are expensive and checking of assertion Cᵢ is non-destructive for the environment (i.e., execution of sequence [perform action “A₁”, check assertion “C₁”, perform “action “A₂”, check assertion “C₂”, etc.] is acceptable in the same environment). In this example, the three approaches outlined in the first example are also possible, but suffer the same disadvantages.

A third example of a type of dependency having repetitive steps among the test cases is similar to the second example, except the subsets mentioned comprise test cases such as:

[T₁₁]—perform action “A₁”, measure some action “MA₁”

[T₁₁,T₁₂]—perform action “A₁”, perform action “A₂”, measure some action “MA₂”.

Frequently in practice the result of MAᵢ is more complicated than just a simple pass/fail/error status, as it has at least 2 raw results: status and a measured value. It is not always possible or reasonable to resolve to the simple pass/fail status inside the sub-testcase just on the basis of measured value because, for example, the values to compare may be expensive to obtain individually or are derived from results of other tests to be executed, there aren't target results defined yet, or at the moment only the MAᵢ execution status is of main interest and the measure are for informational purposes only and to be analyzed later. The approach generally used for this example is to develop some additional separate way to store and later handle the measured value.

It would be beneficial if there was a solution that permitted multiple levels of test-cases, such that hierarchical testing could be performed by the harness without the need for additional processor usage after the test suite is performed.

### BRIEF DESCRIPTION

A hierarchical multi-level logical architecture for a test suite may be provided along with a harness that supports such architecture. At each level in the hierarchy, instructions at the level may be run. A subset of test cases corresponding to the test case currently being examined may then be obtained (which may have been passed by a parent). Then a loop may be entered wherein for each test case in the list of test cases, the test case is executed and the result put into a special data structure, which may then be labeled and returned to the parent. This iterative process allows for multi-level test cases without suffering the drawbacks of the prior art.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a typical test suite.

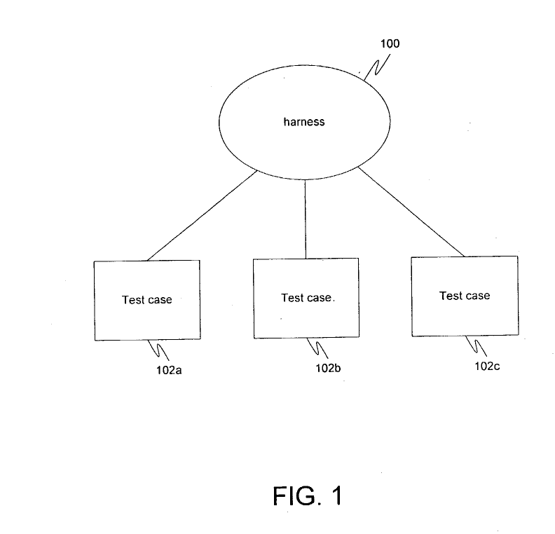

FIG. 2 is a diagram illustrating a tree structure representing test cases in accordance with an embodiment of the present invention.

FIG. 3 is a flow diagram illustrating a method for test case execution in a computer system in accordance with an embodiment of the present invention.

FIG. 4 is a block diagram illustrating an apparatus for test case execution in a computer system in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention utilizes a hierarchical multi-level logical architecture for a test suite and a harness that supports such architecture. At each level in the hierarchy, instructions at the level may be run. A subset of test cases corresponding to the test case currently being examined may then be obtained (which may have been passed by a parent). Then a loop may be entered wherein for each test case in the list of test cases, the test case is executed and the result put into a special data structure, which may then be labeled and returned to the parent. This iterative process allows for multi-level test cases without suffering the drawbacks of the prior art.

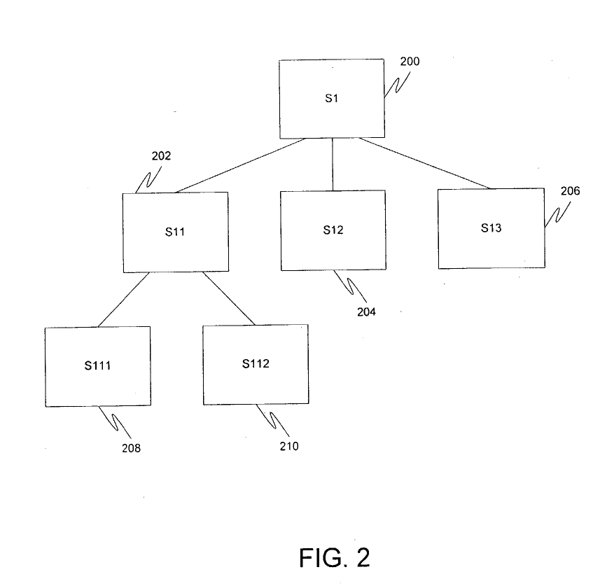

Thus, a test case in itself may be implemented as a harness (“child”) for sub-test cases, and a parent harness is ready to receive, correctly associate, and report the set of resulting data structures. FIG. 2 is a diagram illustrating a tree structure representing test cases in accordance with an embodiment of the present invention. A root test case S₁ 200 may comprise three test cases 202, 204, 206 as direct children, and then two more test cases 208, 210 as grandchildren. This example depicts a 3-level hierarchy, but one of ordinary skill in the art will recognize that the present invention could be extended to any number of levels. Upon execution, the harness may begin with the root test case 200. First, a set of instructions for this test case is executed. The set of instructions would typically include instructions regarding the creation of an environment common to the children test cases (and may be empty for any test case other than leaf test cases, but that is not necessary). The instructions could also, for example, indicate information to be printed on the display or other helpful instructions. For test cases with no children (leaf test cases), the instructions will likely be more complex, describing precisely how a result is to be determined by applying a set of inputs to the software being tested. Then the root test case receives the set of every test case in the hierarchy. Thus, the root test case will receive the set [S₁, S₁₁, S₁₂, S₁₃, S₁₁₁, S₁₁₂]. From this, the root test case can determine that three children S₁₁, S₁₂, and S₁₃ need to be executed. It may then set forth to execute the three children S₁₁, S₁₂, and S₁₃ using instructions.

Since S₁ 200 now must call a child test case S₁₁ 202, it passes to S₁ 202 the subset of all test cases corresponding to S₁₁ 202. Thus, if the original set of test cases is [S₁, S₁₁, S₁₂, S₁3, S₁₁, S₁₁₂], the subset passed to S₁₁ 202 may be [S₁₁, S₁₁₁, S₁₁₂]. S₁₁ 202 then begins its loop, and finds that S₁₁₁ 208 and S₁₁₂ 210 should be executed. Thus, first the subset [S₁₁₁] is passed to S₁₁₁ 208. Since S₁₁₁ 208 does not have any children, it can simply execute its instructions and result in pass or fail (or error). The result may be placed in a data structure and labeled as S₁₁₁. This data structure may then be passed back up to S₁₁ 202. Then S₁₁ 202 may pass the subset [S₁₁₂] to S₁₁₂ 210. S₁₁₂ 210 may then follow the same procedure as S₁₁₁ 208 and return a labeled data structure with the result. S₁₁ 202 will then have executed all its sub-test cases, and thus be ready to base its own result on the results in the set of data structures [S₁₁₁, S₁₁₂] (for example, it would typically return “pass” if all its sub-test cases returned pass, and fail otherwise). Then, the set of results [S₁, S₁₁₁, S₁₁₂] may be passed back to S₁ 200. Similar loops may take place then for S₁₂ 204 and S₁₃ 206, resulting in S₁ being able to base its own result on the set of results [S₁₁, S₁₂, S₁₃, S₁₁₁, S₁₁₂], and then return the entire set of data structures [S₁, S₁₁, S₁₂, S₁₃, S₁₁₁, S₁₁₂] to the user.

Thus result of the entire execution may be a simple “pass or fail”. A pass would indicate that every sub-test case was successful. A “fail” would indicate that at least one of the sub-test cases failed. The user would then have at his disposal the set of data structures [S₁, S₁₁, S₁₂, S₁₃, S₁₁₁, S₁₁₂] in which to examine to determine the source of the problem test cases

This then allows the possibility of a test-case to be a sub-test suite by itself, which is extremely useful when test case functionality comprises mainly execution of harnesses for a subset of test cases. It also allows practically unrestricted depths of harness nodes. Rather complicated resulting data structures may be gathered during traversal of the logical tree of suite execution in a way that each resulting data structure is uniquely associated with the logical path inside the tree of the node that produced the resulting data structure, which allows for fine “granularity” of results.

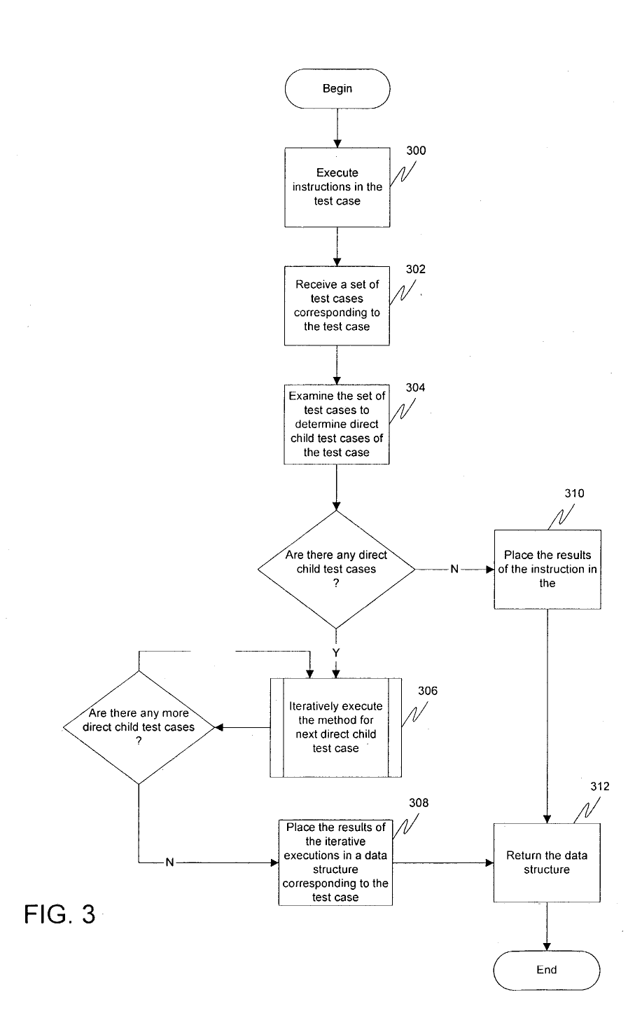

FIG. 3 is a flow diagram illustrating a method for test case execution in a computer system in accordance with an embodiment of the present invention. The test case may comprise a hierarchy of three or more levels of test cases, wherein a root test case has children test cases but no parent test case, each of a plurality of leaf test cases has a parent test case but no children test cases, and intermediate nodes each have a parent test case and one or more children test cases. Thus, the hierarchy may be described as having three or more levels. While the first level will always have the root test case, and the last level have only leaf test cases, it is not necessary that all leaf test cases are located on the bottom level.

The method described in FIG. 3 may be repeated for each test case and sub-test case in the hierarchy in a recursive manner. At 300, instructions in the test case may be executed. The set of instructions would typically be empty for any test case other than leaf test cases, but that is not necessary. The instructions could, for example, indicate information to be printed on the display or other helpful instructions. For test cases with no children (leaf test cases), the instructions will likely be more complex, describing precisely how a result is to be determined by applying a set of inputs to the software being tested. At 302, a set of test cases corresponding to the test case may be received If this is the root test case, the set of test cases may simply be provided by a user, but for any other test case, the set of test cases will be received from a parent test case. The set of test cases corresponding to a given test case will typically comprise the given test case and any descendants of the given test case. Often, the test case labels will be such that this information can be culled simply from a list of test cases. For example, if a set of test cases [S₁₁, S₁₁₁, S₁₁₂] is received at test case S₁₁, the labeling scheme indicates that test case S₁₁ has two children, S₁₁₁ and S₁₁₂. Therefore, at 304, the set of test cases may be examined to determine direct child test cases of the test case. A direct child test case would be a child test case that is only one level removed from the given test case (i.e., children, but not grandchildren, great-grandchildren, etc.).

At 306, the method may be iteratively executed for each of the direct child test cases of the test case (assuming there are any). Additionally, a subset of test cases may be passed to each of the direct child test cases up their corresponding iteration, the subset of test cases containing test cases corresponding to the direct child test case. At 308, results of the iterative executions may be placed in a data structure corresponding to the test case. If however, there are no direct child test cases of the test case then at 310, results of the instruction execution in 300 may be placed in the data structure. At 312, the data structure may be returned. If the current test case being examined is not the root test case, the data structure will be passed up iteratively. If it is the root test case, it may simply be returned to the user.

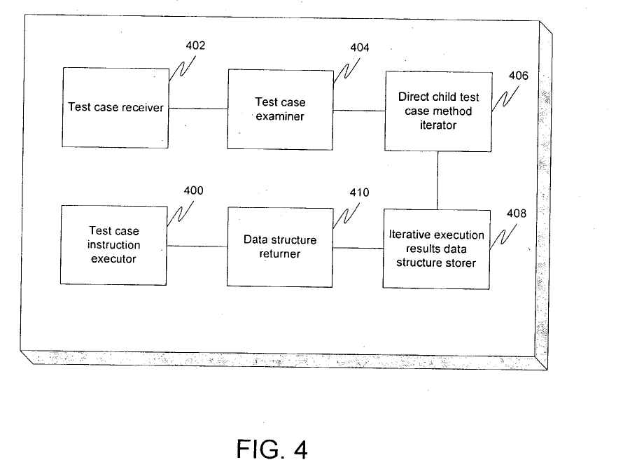

FIG. 4 is a block diagram illustrating an apparatus for test case execution in a computer system in accordance with an embodiment of the present invention. The test case may comprise a hierarchy of three or more levels of test cases, wherein a root test case has children test cases but no parent test case, each of a plurality of leaf test cases has a parent test case but no children test cases, and intermediate nodes each have a parent test case and one or more children test cases. Thus, the hierarchy may be described as having three or more levels. While the first level will always have the root test case, and the last level have only leaf test cases, it is not necessary that all leaf test cases are located on the bottom level.

The apparatus described in FIG. 4 may repeat a method for each test case and sub-test case in the hierarchy in a recursive manner. A test case instruction executor 400 may execute instructions in the test case. The set of instructions would typically be empty for any test case other than leaf test cases, but that is not necessary. The instructions could, for example, indicate information to be printed on the display or other helpful instructions. For test cases with no children (leaf test cases), the instructions will likely be more complex, describing precisely how a result is to be determined by applying a set of inputs to the software being tested. A set of test cases receiver 402 may receive a set of test cases corresponding to the test case. If this is the root test case, the set of test cases may simply be provided by a user, but for any other test case, the set of test cases will be received from a parent test case. The set of test cases corresponding to a given test case will typically comprise the given test case and any descendants of the given test case. Often, the test case labels will be such that this information can be culled simply from a list of test cases. For example, if a set of test cases [S₁₁, S₁₁₁, S₁₁₂] is received at test case S₁₁, the labeling scheme indicates that test case S₁₁ has two children, S₁₁₁ and S₁₁₂. Therefore, a test case examiner 404 coupled to the set of test cases receiver 402 may examine the set of test cases may be examined to determine direct child test cases of the test case. A direct child test case would be a child test case that is only one level removed from the given test case (i.e., children, but not grandchildren, great-grandchildren, etc.).

A direct child test case method iterator 406 coupled to the test case examiner 404 may iteratively execute the method for each of the direct child test cases of the test case (assuming there are any). Additionally, a subset of test cases may be passed to each of the direct child test cases up their corresponding iteration, the subset of test cases containing test cases corresponding to the direct child test case. An iterative execution results data structure storer 408 coupled to the direct child test case method iterator 406 may store results of the iterative executions in a data structure corresponding to the test case. A data structure returner 410 coupled to said iterative execution results data structure storer and to the test case instruction executor 400 may return the data structure may be returned. If however, there are no direct child test cases of the test case, results of the instruction execution may be placed in the data structure before it is returned. If the current test case being examined is not the root test case, the data structure will be passed up iteratively. If it is the root test case, it may simply be returned to the user.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for test case execution in a computer system, the method being executed for each of a plurality of test cases in a hierarchy of test cases beginning with a root test case, the method comprising:
executing instructions in the test case;
receiving a set of test cases corresponding to the test case;
examining said set of test cases to determine direct child test cases of the test case;
iteratively executing the method for each of said direct child test cases of the test case, passing a subset of test cases to each of said direct child test cases, said subset of test cases containing test cases corresponding to said direct child test case;
placing results of said iterative executions in a data structure corresponding to the test case, or placing results of said instructions in said data structure if there are no direct child test cases of the test case; and
returning said data structure.

2. The method of claim 1, wherein said set of test cases corresponding to the test case includes a hierarchy of test cases having the test case as a root.

3. The method of claim 1, wherein said subset of test cases corresponding to said direct child test case includes a hierarchy of test cases having the direct child test case as a root.

4. The method of claim 1, wherein said set of test cases is stored as a list.

5. The method of claim 4, wherein the hierarchy of said set of test cases is identified by examining a label of each of said test cases in said list.

6. The method of claim 1, wherein said subset of test cases is stored as a list.

7. The method of claim 6, wherein the hierarchy of said subset of test cases is identified by examining a label of each of said test cases in said list.

8. The method of claim 1, wherein said instructions indicate how a result is to be determined by applying a set of inputs to software being tested.

9. The method of claim 1, wherein at each test case, a pass is returned as said result only if all direct child test cases returned pass.

10. The method of claim 1, wherein said hierarchy of test cases comprises at least three levels of test cases.

11. A method for test case execution in a computer system, the method being executed for each of a plurality of test cases in a hierarchy of test cases beginning with a root test case representing a test case with no parent, said hierarchy being further composed of a plurality of leaf test cases, representing test cases with no children, and one or more intermediate test cases, representing test cases having both a parent and at least one child, the method comprising:
executing instructions in the test case, said instructions indicating how a result is to be determined by applying a set of inputs to software being tested if the test case is a leaf test case;
receiving a set of test cases corresponding to the test case;
examining said set of test cases to determine direct child test cases of the test case;
iteratively executing the method for each of said direct child test cases of the test case, passing a subset of test cases to each of said direct child test cases, said subset of test cases containing test cases corresponding to said direct child test ease;
placing results of said iterative executions in a data structure corresponding to the test case, or placing results of said instructions in said data structure if there are no direct child test cases of the test case; and
returning said data structure.

12. The method of claim 11, wherein said set of test cases corresponding to the test case includes a hierarchy of test cases having the test case as a root.

13. The method of claim 11, wherein said subset of test cases corresponding to said direct child test case includes a hierarchy of test cases having the direct child test case as a root.

14. The method of claim 11, wherein said set of test cases is stored as a list.

15. The method of claim 14, wherein the hierarchy of said set of test cases is identified by examining a label of each of said test cases in said list.

16. The method of claim 11, wherein said subset of test cases is stored as a list.

17. The method of claim 16, wherein the hierarchy of said subset of test cases is identified by examining a label of each of said test cases in said list.

18. The method of claim 11, wherein at each test case, a pass is returned as said result only if all direct child test cases returned pass.

19. The method of claim 11, wherein said hierarchy of test cases comprises at least three levels of test cases.

20. An apparatus for test case execution in a computer system, the apparatus executing a method for each of a plurality of test cases in a hierarchy of test cases beginning with a root test case, the apparatus comprising:
a test case instruction executor;
a set of test cases receiver;
a test case examiner coupled to said set of test cases receiver;
a direct child test case method iterator coupled to said test case examiner;
an iterative execution results data structure storer coupled to said direct child test case method iterator; and
a data structure returner coupled to said iterative execution results data structure storer and to said test case instruction executor.

21. An apparatus for test case execution in a computer system, the method being executed for each of a plurality of test cases in a hierarchy of test cases beginning with a root test case, the apparatus comprising:
means for executing instructions in the test case;
means for receiving a set of test cases corresponding to the test case;
means for examining said set of test cases to determine direct child test cases of the test case;
means for iteratively executing the method for each of said direct child test cases of the test case, passing a subset of test cases to each of said direct child test cases, said subset of test cases containing test cases corresponding to said direct child test case;
means for placing results of said iterative executions in a data structure corresponding to the test case, or placing results of said instructions in said data structure if there are no direct child test cases of the test case; and
means for returning said data structure.

22. The apparatus of claim 21, wherein said set of test cases corresponding to the test case includes a hierarchy of test cases having the test case as a root.

23. The apparatus of claim 21, wherein said subset of test cases corresponding to said direct child test case includes a hierarchy of test cases having the direct child test case as a root.

24. The apparatus of claim 21, wherein said set of test cases is stored as a list.

25. The apparatus of claim 24, wherein the hierarchy of said set of test cases is identified by examining a label of each of said test cases in said list.

26. The apparatus of claim 21, wherein said subset of test cases is stored as a list.

27. The apparatus of claim 26, wherein the hierarchy of said subset of test cases is identified by examining a label of each of said test cases in said list.

28. The apparatus of claim 21, wherein said instructions indicate how a result is to be determined by applying a set of inputs to software being tested.

29. The apparatus of claim 21, wherein at each test case, a pass is returned as said result only if all direct child test cases returned pass.

30. The apparatus of claim 21, wherein said hierarchy of test cases comprises at least three levels of test cases.

31. An apparatus for test case execution in a computer system, the apparatus executing a method for each of a plurality of test cases in a hierarchy of test cases beginning with a root test case representing a test case with no parent, said hierarchy being further composed of a plurality of leaf test cases, representing test cases with no children, and one or more intermediate test cases, representing test cases having both a parent and at least one child, the apparatus comprising:
means for executing instructions in the test case, said instructions indicating how a result is to be determined by applying a set of inputs to software being tested if the test case is a leaf test case;
means for receiving a set of test cases corresponding to the test case;
means for examining said set of test cases to determine direct child test cases of the test case;
means for iteratively executing the method for each of said direct child test cases of the test case, passing a subset of test cases to each of said direct child test cases, said subset of test cases containing test cases corresponding to said direct child test case;
means for placing results of said iterative executions in a data structure corresponding to the test case, or placing results of said instructions in said data structure if there are no direct child test cases of the test case; and
means for returning said data structure.

32. The apparatus of claim 31, wherein said set of test cases corresponding to the test case includes a hierarchy of test cases having the test case as a root.

33. The apparatus of claim 31, wherein said subset of test cases corresponding to said direct child test case includes a hierarchy of test cases having the direct child test case as a root.

34. The apparatus of claim 31, wherein said set of test cases is stored as a list.

35. The apparatus of claim 34, wherein the hierarchy of said set of test cases is identified by examining a label of each of said test cases in said list.

36. The apparatus of claim 31, wherein said subset of test cases is stored as a list.

37. The apparatus of claim 36, wherein the hierarchy of said subset of test cases is identified by examining a label of each of said test cases in said list.

38. The apparatus of claim 31, wherein at each test case, a pass is returned as said result only if all direct child test cases returned pass.

39. The apparatus of claim 31, wherein said hierarchy of test cases comprises at least three levels of test cases.

40. A program storage device readable by a machine, tangibly embodying a program of instructions executable by the machine to perform a method for test case execution in a computer system, the method being executed for each of a plurality of test cases in a hierarchy of test cases beginning with a root test case, the method comprising:
executing instructions in the test case;
receiving a set of test cases corresponding to the test case;
examining said set of test cases to determine direct child test cases of the test case;
iteratively executing the method for each of said direct child test cases of the test case, passing a subset of test cases to each of said direct child test cases, said subset of test cases containing test cases corresponding to said direct child test case;
placing results of said iterative executions in a data structure corresponding to the test case, or placing results of said instructions in said data structure if there are no direct child test cases of the test case; and
returning said data structure.

41. A program storage device readable by a machine, tangibly embodying a program of instructions executable by the machine to perform a method for test case execution in a computer system, the method being executed for each of a plurality of test cases in a hierarchy of test cases beginning with a root test case representing a test case with no parent, said hierarchy being further composed of a plurality of leaf test cases, representing test cases with no children, and one or more intermediate test cases, representing test cases having both a parent and at least one child, the method comprising:
executing instructions in the test case, said instructions indicating how a result is to be determined by applying a set of inputs to software being tested if the test case is a leaf test case;
receiving a set of test cases corresponding to the test case;
examining said set of test cases to determine direct child test cases of the test case;
iteratively executing the method for each of said direct child test cases of the test case, passing a subset of test cases to each of said direct child test cases, said subset of test cases containing test cases corresponding to said direct child test case;
placing results of said iterative executions in a data structure corresponding to the test case, or placing results of said instructions in said data structure if there are no direct child test cases of the test case; and
returning said data structure.
